(19) United States
(12) Patent Application Publication
(10) Pub. No.: US 2005/0000812 A1
(43) Pub. Date: Jan. 6, 2005

(54) Apparatus for electrophoresis separation on microchannels and for laser-induced fluorescence detection

(76) Inventors: Francois Couderc, Toulouse (FR); Michel Nertz, Sainte Foy D'Aigrefeuille (FR); Bernard Feurer, Toulouse (FR)

Correspondence Address: YOUNG & THOMPSON, 745 SOUTH 23RD STREET, 2ND FLOOR, ARLINGTON, VA, 22202, US

(21) Appl. No.: 10/484,847

(22) PCT Filed: Jul. 22, 2002
(86) PCT No.: PCT/FR02/02612

(30) Foreign Application Priority Data
Jul. 25, 2001 (FR) 01 09955

(51) Int. Cl. C02F 1/40; C25B 11/00; G01N 27/27

(52) U.S. Cl. 204/600

(57) ABSTRACT

An integrated apparatus includes a miniaturized flattened support having a planar surface whereon are formed wells and a microchannel, elements for projecting exciting light locally on an excitation zone of the microchannel along a direction forming an angle (α) greater than 60° with a longitudinal direction of the microchannel, optical collector elements coupled with one free end of the microchannel, optical measurement elements and processing elements, the microchannel having a portion forming a reservoir with internal cross-section flaring from its free end up to the excitation zone, the portion being extended by a conical, ellipsoidal or paraboloidal internal wall, and emerging onto a second microchannel portion with reduced internal cross-section, the latter communication with the wells.

The present invention relates to an apparatus for electrophoretic separation and for laser-induced fluorescence detection, in order to produce fluorescence light from substances dissolved in liquid streams contained in microchannels formed on miniaturized flattened supports and to detect this light for the purpose of chemical or biochemical analysis.

It is known to take laser-induced fluorescence measurements in order to identify and assay substances present in a solution, particularly in trace form. Such measurements have many applications, for example in biochemistry.

Electrophoretic separation in liquid streams contained in microchannels inscribed on miniaturized flattened supports allows very small volumes of complex mixtures to be very rapidly separated. The small volume of specimen injected, the low concentrations of species to be analyzed and the small dimensions of the liquid streams (a few μm) mean that a very sensitive detection method has to be used.

The optical detection method most commonly employed on liquid streams contained in microchannels inscribed on miniaturized flattened supports is laser-induced fluorescence. This detection method is sensitive since it allows the liquid microstream to be illuminated at a discrete point with a high irradiance. The optical arrangement commonly used for such detection on a liquid microstream is a confocal arrangement using the principle of confocal epifluorescence microscopy (cf. G. J. M. Bruin, Electrophoresis (2000), Vol. 21, pages 3931-3951).

In these confocal systems, the efficiency of fluorescence collection is low. This is because the volume of liquid illuminated is small, for example of the order of a few hundred μm³, and the volume of liquid observed is even smaller, of the order of 1 μm³. It is therefore necessary to limit the depth of field in order to observe this fluorescence-emitting volume, which means that it is not possible to collect all the fluorescence emitted in the liquid stream. Since this depth of field is small, the numerical aperture of the objective used is even larger, which necessitates very short working distances. However, when a sheet of polymer or of silica covers the microchannels inscribed on a miniaturized flattened support, the experimenter must use objectives with a longer working distance and he therefore collects less of the fluorescence signal. Furthermore, it is extremely tricky to position such a detector in order to collect the fluorescence, since the tolerances in positioning the objective on the microchannel are very small (less than one micron).

Document WO 00/04371 proposes a capillary electrophoresis arrangement using a silica capillary coated on the outside with a layer of a polymer having a refractive index less than that of a separation medium that fills the inside of the capillary, in which arrangement the capillary is illuminated in an orthogonal geometry, the direction of propagation of the excitation light being transverse to the capillary, whereas the fluorescence light is collected in the axial direction of the capillary. According to that document, the light that is emitted or scattered near the outer surface of the capillary propagates as a spiral along the entire length of the capillary near its outer surface, whereas the light emitted at the center of the capillary, such as the laser-induced fluorescence, statistically leaves the capillary near its center, thereby allowing the stray light to undergo spatial filtering at the detector. However, that document does not describe the application to liquid streams contained in microchannels inscribed on miniaturized flattened supports.

The object of the present invention is to provide an apparatus for electrophoretic separation and for high-sensitivity laser-induced fluorescence detection, for liquid streams contained in microchannels formed on miniaturized flattened supports, which does not have the aforementioned drawbacks or some of them.

To do this, the invention provides an apparatus for electrophoretic separation on a liquid stream and for laser-induced fluorescence detection, characterized in that it comprises:
a miniaturized flattened support having a substantially planar surface, on which surface at least one well containing the separation electrolyte and/or the specimen to be analyzed and at least one migration microchannel serving as the liquid stream are formed, said microchannel being capable of containing a solution comprising at least one substance that can undergo a laser-induced fluorescence reaction, the material of said support preferably being substantially transparent to excitation light;
at least one projection means capable of projecting an excitation light beam locally onto an excitation region of said microchannel in a direction making an angle of greater than 60° with a longitudinal direction of said microchannel, said excitation light being capable of inducing a fluorescence reaction in said substance or one of said substances;
an optical collecting means mechanically coupled to a free end of said microchannel and placed so as to collect fluorescence light propagating substantially along the longitudinal direction of the microchannel;
an optical measurement means coupled to said collecting means so as to be able to measure said collected fluorescence light; and
a processing means capable of processing a measurement signal transmitted by said measurement means in order to produce a result of the analysis of said solution;
   said microchannel having a first portion forming a reservoir with an internal cross section that widens from its free end up to at least said excitation region, said first portion being extended by a first internal wall of approximately conical, ellipsoidal or paraboloidal shape, one face of which is turned toward said free end and is capable of reflecting said fluorescence light toward said free end, and emerging in a second microchannel portion having a smaller internal cross section, this latter portion being in communication with the aforementioned well or wells.

This apparatus is particularly effective thanks to the use of a conical, ellipsoidal or paraboloidal wall for the liquid stream in the region of the laser illumination, which wall allows the fluorescence to be reflected toward an optical fiber fixed to the free end of the liquid stream.

Advantageously, said internal wall of approximately conical, ellipsoidal or paraboloidal shape is coated with a metallic oxidation-resistant reflective coating, for example made of gold, aluminum, silver or platinum, especially by a vacuum evaporation deposition process.

According to another feature, all the walls of the microchannel in the excitation region are coated with this reflective material except for at least one part of the end wall of the microchannel, which part is devoid of said reflective material near the aforementioned internal walls of conical, ellipsoidal or paraboloidal shape.

Advantageously, said support includes at least two electrodes that are connected to a voltage source and are placed at a well and at said excitation region of the microchannel, respectively, so as to be able to establish a potential drop along said microchannel in order to make said dissolved substance or one of said dissolved substances migrate by electrophoresis.

Advantageously, the metallic coating on said approximately conical, ellipsoidal or paraboloidal internal wall serves as cathode electrode.

Preferably, the projection means comprises a light source, which is placed laterally at a certain distance from the microchannel, and optical means that are placed between the light source and the microchannel in order to match the cross section of said excitation light beam to the internal width of said microchannel.

Advantageously, the laser beam has an elliptical cross section, the major axis of which is perpendicular to the longitudinal axis of the microchannel and extends substantially over the width of the microchannel, the minor axis being approximately parallel to or coincident with said longitudinal axis of the microchannel, thereby making it possible to maintain the electrophoretic separation resolution.

Advantageously, the support could be made of a material having a reflection index less than that of water.

Said support may also be made of a material whose refractive index is greater than that of water, for example made of silica.

For the purpose of the invention, the water in the microchannel is an electrolyte consisting essentially of water (with a refractive index of about 1.33 for a wavelength of about 488 nm) or of water-miscible organic solvents, acids or water-soluble salts, that are commonly used for transporting substances to be separated, or else a hydrogel (for example with a refractive index of about 1.36).

Preferably, said microchannel has a depth of at most 100 μm, and generally about 10 μm, and a width of at most 400 μm, and generally about 50 μm. The cross section of the microchannel is preferably rectangular and open to said plane surface of the support, but it may also be semicircular. The microchannel may be left open to the air, but it may also be covered with a glass plate having a thickness of one millimeter, or another transparent material.

The invention will be better understood and other objects, details, features and advantages thereof will become more clearly apparent in the course of the following description of one particular embodiment of the invention, given solely by way of illustration but implying no limitation, and with reference to the appended drawings. In these drawings:

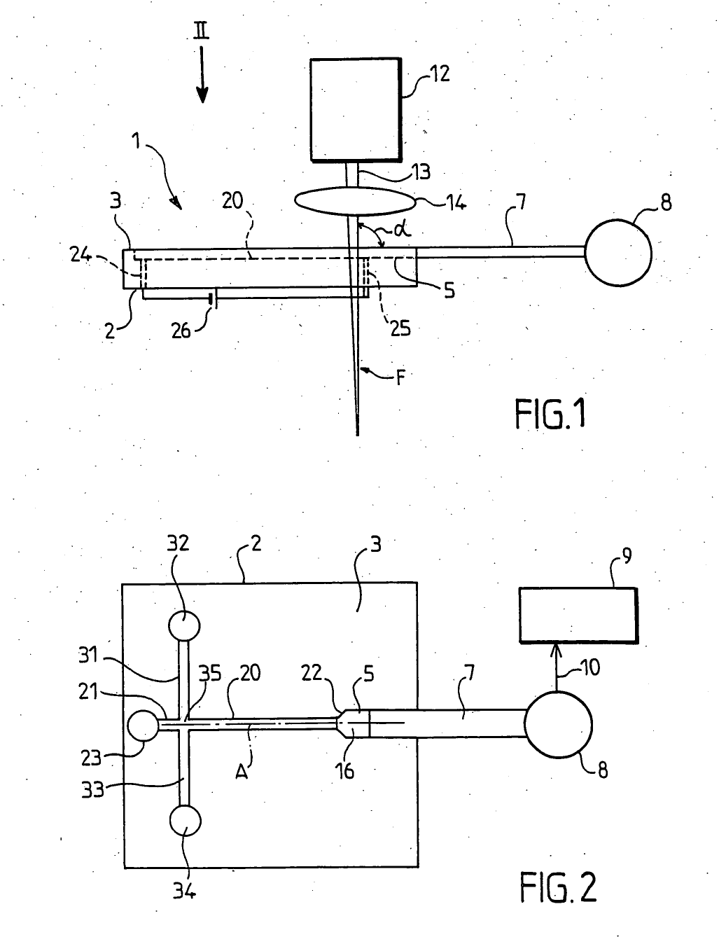

FIG. 1 is a schematic side view of an apparatus according to the invention;

FIG. 2 is a top view of FIG. 1, looking along the arrow II; and

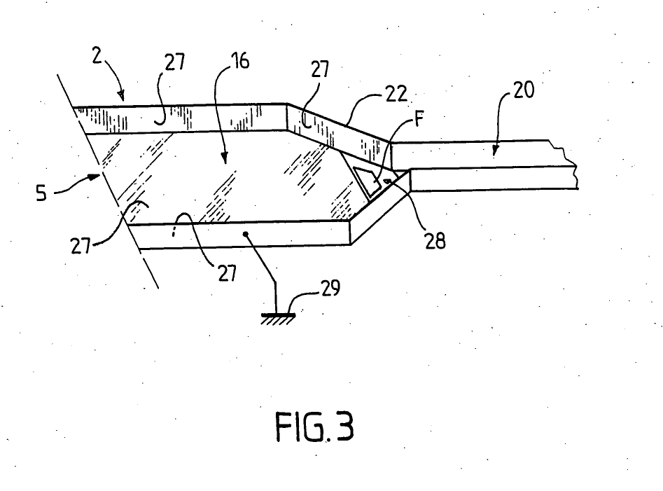

FIG. 3 is an enlarged view of a detail of the apparatus of FIG. 1.

In FIG. 1, the analysis device 1 is integrated into a miniaturized separation apparatus having microchannels 20, 21, 31 and 33, forming liquid streams, formed on the plane surface 3 of a polymer or silica support 2 of parallelepipedal shape. Chemical species in an electrolyte solution filling the channels are made to migrate under the effect of an electrical potential difference produced by a DC voltage source 26. The polymer of the material 2 may be a polymer having a refractive index less than that of the electrolyte solution. The liquid stream or streams containing the chemical species that have to be detected by fluorescence, that is to say the channels 20 and 21 in the example shown, have, at a blind first end, an anode well 23, in which an anode electrode 24 is in electrical contact with the electrically conducting solution, and, near a free second end, an enlarged excitation region 16 in which a cathode electrode 25 is in electrical contact with the solution. The electrodes 24 and 25 are connected to the voltage source 26, for example via electrical contacts fixed to the surface of the substrate 2 on the opposite side from the channels 20 and 21.

The enlarged excitation region 16 is illuminated by a projection means comprising an excitation light source 12 (which may be a laser or a lamp) and a set of lenses 14. The excitation light source 12 projects an excitation light beam 13 in a direction of incidence making an angle α of greater than 60°, and substantially equal to 90° in FIG. 1, with the axial direction A of the channel 20, and the set of lenses 14 allows the excitation light beam F to be matched to the cross section of the enlarged excitation region 16 of the channel 20.

Said enlarged excitation region is contained in an enlarged portion of the channel 20 and forms a reservoir 5 to its free end toward a collecting optical fiber 7 placed along the extension of the channel 20. Said reservoir 5 is extended, on the opposite side, by an internal wall 22 of approximately conical, ellipsoidal or paraboloidal shape, one face of which is turned toward said free end and is capable of reflecting said fluorescence light toward said free end. Said wall 22 ends on a second portion of the microchannel 20 having a reduced internal cross section, this second portion being in communication with the aforementioned well 23 via the microchannel 21. The mechanical coupling between the optical fiber 7 and the support 2 is achieved by embedding, in a sealed manner, or adhesively bonding an end part of the optical fiber 7 in a groove 5 having a rectangular or semicylindrical cross section of corresponding size formed in the surface of the support 2 along the extension of the channel 20. The diameter of the optical fiber is at least the same as the width of the enlarged excitation region 16.

The directional excitation light beam 13 passes through a set of lenses 14 which are adapted in order to make the beam F converge on the portion 16 of the microchannel 20 so that the diameter of the beam F in the microchannel 20 is approximately equal to the width of the portion 5 of the microchannel 20. Thus, the loss of some of the excitation light that would not be encountered by the solution is minimized, whereas the volume of solution illuminated remains sufficient to induce fluorescence light in an amount that can be detected right from very low concentrations of fluorescent substance.

The set of lenses 14 could also make the beam F diverge, for example in the case in which the source 12 produces a beam 13 narrower than the inside of the microchannel 20.

Preferably, if the direction of incidence of the beam F with respect to the axis A is inclined, it is inclined so as to reduce the angle α between said direction of incidence and the axis A located on the same side as the optical fiber 7, in order to direct the excitation light away from said optical fiber and thus reduce the scattering of excitation light toward the measurement means.

The optical fiber(s) 7 axially collects (collect) the emitted fluorescence light and guides (guide) it as far as a photomultiplier tube 8, or any other type of optical detector. The photomultiplier tube 8 produces a measurement signal that is conveyed by a suitable linking means 10 to a data processing system 9, for example a microcomputer, which includes software means, known to those skilled in the art, for processing the measurement signal received and for producing an analysis result, for example absolute or relative quantitative measurements of the concentration of the substance or substances emitting fluorescence light.

Because of the good optical transmission between the microchannel 20 and the collecting fiber 7, it is unnecessary to provide spectral or spatial filtering means between the microchannel 20 and the optical detector, although it is possible to do so in order to improve the detection threshold. Although not shown, electrical power supply means are incorporated into or connected to the photomultiplier tube 8 and to the light source 12 in order to operate them.

As may be seen in FIG. 2, the electrophoretic separation device according to the invention, for example operating by electromigration, electroendosmosis, zone or micellar electrophoresis, isotachophoresis or electrochromatography, comprises an electrolyte solution contained in the wells 23, 32 and 34 and the microchannels 20, 21, 31 and 33. For example, the well 32 contains a lateral buffer allowing migration, the well 23 contains the specimen to be analyzed, and the well 34 a reactive dye in order to produce a fluorescent derivative upon contact with the substance to be analyzed and detected, should said substance not emit fluorescence or not enough fluorescence under the excitation light. Each of the wells is provided with an anode electrode which is activated in a predetermined order. For example, provision may be made for the electrode associated with the well 23 to be activated first, so that the substances to be detected migrate to the intersection 35 between the various microchannels, then the electrode associated with the well 34 is activated instead, so that the reactive agent in turn reaches said intersection, and therefore the substance that has migrated beforehand to the intersection, and reacts with said substance and, finally, the electrode associated with the well 32 is activated, so that said substances are separated in the microchannel 20 as far as the excitation region 16. Of course, the invention is not limited to three wells, but covers embodiments having one or more wells and one or more separation microchannels.

The electrolyte is in electrical contact with each electrode immersed in the corresponding well or the reservoir 5. The electrodes may be integrated into the support 2.

This enlargement of the microchannel 20 in the excitation region 16 allows a larger specimen volume to be irradiated.

FIG. 3 shows a detail of the enlarged excitation region. The wall 22 has a conical or ellipsoidal or paraboloidal face in order to promote reflection of the fluorescence light toward a collecting optical fiber 7 placed along the extension of the groove 5 at its cathode end. A metallic mirror coating 27, made of gold, silver, aluminum or platinum, is deposited, for example by a vacuum evaporation deposition process on the bottom of the microchannel and on its side walls, except for a part 28 of the bottom of the microchannel adjacent to said wall 22 in order to prevent the light beam F from being reflected into the microchannel. The metallic surface 27 may be grounded 29 so as to close the electrical circuit delivering the DC voltage 26.

In order to excite the fluorescence of several substances simultaneously, several projection means may also be provided with excitation light sources having different wavelengths, these being placed side by side along the support 2 and/or around its periphery. In this case, the various substances will fluoresce at different wavelengths and it will be opportune to add, downstream of the collection means, a spectral separation system, of the optical filter, prism monochromater or diffraction grating type, allowing one or more emission wavelength bands to be selected. This will also be the case if the excitation source is a laser emitting in the UV, it then being possible for the various substances to each exhibit a specific native fluorescence.

This apparatus is advantageous for fluorescence detection on multiple separation microchannels, requiring fluorescence collection on each of the microchannels, since the use of a bundle of optical fibers (one optical fiber per microchannel) is facilitated. In this case, the excitation may be effected either by splitting the laser beam by means of a bundle of optical fibers, or by rapid scanning using a rotating mirror.

In order to maintain the electrophoretic and chromatographic resolutions, the excitation beam F may have a cross section of elliptical shape, the major axis of this ellipse being perpendicular to the longitudinal axis A of the microchannel and the minor axis of this ellipse being parallel to said axis A.

Although the invention has been described in relation to one particular embodiment, it is obvious that it is in no way limited thereby and that it includes all the technical equivalents of the means described as well as their combinations, provided that they fall within the scope of the invention.

1. An integrated apparatus (1) for electrophoretic separation on a liquid stream and for laser-induced fluorescence detection, characterized in that it comprises:
a miniaturized flattened support (2) having a substantially planar surface (3), on which surface at least one well (23, 32, 34) containing the separation electrolyte and/or the specimen to be analyzed and at least one migration microchannel (20, 21, 31, 33) serving as the liquid stream are formed, said microchannel being capable of containing a solution comprising at least one substance that can undergo a laser-induced fluorescence reaction;
at least one projection means (12) capable of projecting an excitation light beam locally onto an excitation region (16) of said microchannel (20) in a direction making an angle (α) of greater than 60° with a longitudinal direction (A) of said microchannel, said excitation light being capable of inducing a fluorescence reaction in said substance or one of said substances;
an optical collecting means (7) mechanically coupled to a free end of said microchannel (20) and placed so as to collect fluorescence light propagating substantially along the longitudinal direction (A) of the microchannel;
an optical measurement means (8) coupled to said collecting means so as to be able to measure said collected fluorescence light; and
a processing means (9) capable of processing a measurement signal transmitted by said measurement means in order to produce a result of the analysis of said solution;
said microchannel (20) having a first portion forming a reservoir (5) with an internal cross section that widens from its free end up to at least said excitation region (16), said first portion being extended by a first internal wall (22) of approximately conical, ellipsoidal or paraboloidal shape, one face of which is turned toward said free end and is capable of reflecting said fluorescence light toward said free end, and emerging in a second microchannel portion having a smaller internal cross section, this latter portion being in communication with the aforementioned well or wells.

2. The apparatus as claimed in claim 1, characterized in that said support includes at least one anode electrode (24) and at least one cathode electrode (25) that are connected to a voltage source (26) and are placed at a well and at said excitation region (16) of the microchannel (20), respectively, so as to be able to establish a potential drop along said microchannel in order to make said dissolved substance or one of said dissolved substances migrate by electrophoresis.

3. The apparatus as claimed in claim 2, characterized in that the approximately conical (218), ellipsoidal or paraboloidal internal wall(s) (22) of the microchannel (20) is (are) coated with a metallic oxidation-resistant reflective material (27).

4. The apparatus as claimed in claim 2 taken in combination, characterized in that the metallic coating (27) on said approximately conical, ellipsoidal or paraboloidal internal wall (22) serves as cathode electrode.

5. The apparatus as claimed in claim 4, characterized in that the metallic coating (27) is grounded (29).

6. The apparatus as claimed in claim 3, characterized in that all the walls of the microchannel in the excitation region (16) are coated with this reflective material (27) except for at least one part (28) of the end wall of the microchannel (20), which part is devoid of said reflective material near the aforementioned internal walls (22) of conical, ellipsoidal or paraboloidal shape.

7. The apparatus as claimed in claim 1, characterized in that said microchannel has a depth of at most 100 μm, and preferably about 10 μm, and a width of at most 400 μm, and preferably about 50 μm.

8. The apparatus as claimed in claim 1, characterized in that said projection means comprises a light source (12), which is placed laterally at a certain distance from said microchannel (20), and optical means (14) that are placed between the light source and the microchannel in order to match the cross section of said excitation light beam (F) to the internal width of said microchannel.

9. The apparatus as claimed in claim 8, characterized in that the laser beam (F) has an elliptical cross section, the major axis of which is perpendicular to the longitudinal axis (A) of the microchannel and extends substantially over the width of the microchannel, the minor axis being approximately parallel to or coincident with said longitudinal axis of the microchannel.

10. The apparatus as claimed in claim 1, characterized in that the cross section of the microchannel (20) is rectangular and open to the air.

11. The apparatus as claimed in claim 1, characterized in that the approximately conical (218), ellipsoidal or paraboloidal internal wall(s) (22) of the microchannel (20) is (are) coated with a metallic oxidation-resistant reflective material (27).

12. The apparatus as claimed in claim 4, characterized in that all the walls of the microchannel in the excitation region (16) are coated with this reflective material (27) except for at least one part (28) of the end wall of the microchannel (20), which part is devoid of said reflective material near the aforementioned internal walls (22) of conical, ellipsoidal or paraboloidal shape.

13. The apparatus as claimed in claim 5, characterized in that all the walls of the microchannel in the excitation region (16) are coated with this reflective material (27) except for at least one part (28) of the end wall of the microchannel (20), which part is devoid of said reflective material near the aforementioned internal walls (22) of conical, ellipsoidal or paraboloidal shape.
